(19) United States
(12) Patent Application Publication
(10) Pub. No.: US 2023/0026609 A1
(43) Pub. Date: Jan. 26, 2023

(54) DRIVING DIAGNOSTIC INFORMATION MANAGEMENT APPARATUS AND DRIVING DIAGNOSTIC INFORMATION MANAGEMENT METHOD

(71) Applicant: TOYOTA JIDOSHA KABUSHIKI KAISHA, Aichi-ken (JP)

(72) Inventors: Masato ENDO, Nagoya-shi, Aichi-ken (JP); Yasuyuki KAMEZAKI, Toyota-shi, Aichi-ken (JP); Yasuhiro MURATA, Toyota-shi, Aichi-ken (JP); Takeo MORIAI, Nagakute-shi, Aichi-ken (JP); Kosuke SAKAKIBARA, Toyota-shi, Aichi-ken (JP); Kenta MIYAHARA, Okazaki-shi, Aichi-ken (JP); Takashi HAYASHI, Nagoya-shi, Aichi-ken (JP)

(21) Appl. No.: 17/829,232

(22) Filed: May 31, 2022

(30) Foreign Application Priority Data
Jul. 26, 2021 (JP) 2021-122031

(51) Int. Cl. G07C 5/08; G07C 5/00

(52) U.S. Cl. CPC G07C 5/0808; G07C 5/008

(57) ABSTRACT

A driving diagnostic information management apparatus includes: a diagnostic information acquisition portion configured to acquire driving diagnostic information on a driver; a storage processing portion configured to store the driving diagnostic information per driver in a storage portion; a reception portion configured to receive a provision request on the driving diagnostic information; and a providing portion configured to, upon receipt of the provision request on the driving diagnostic information, provide the driving diagnostic information on a driver corresponding to the provision request.

### CROSS-REFERENCE TO RELATED APPLICATION

This application claims priority to Japanese Patent Application No. 2021-122031 filed on Jul. 26, 2021, incorporated herein by reference in its entirety.

### BACKGROUND

### 1. Technical Field

The present disclosure relates to a driving diagnostic information management apparatus and a driving diagnostic information management method.

### 2. Description of Related Art

Japanese Unexamined Patent Application Publication No. 2004-295521 (JP 2004-295521 A) describes a taxi evaluation method for evaluating a taxi. More specifically, in the taxi evaluation method described in JP 2004-295521 A, evaluation on a taxi driver is performed such that a customer taking a taxi inputs an evaluation on the taxi.

### SUMMARY

However, in the taxi evaluation method described in JP 2004-295521 A, only a taxi management company can know an evaluation result, and therefore, there is room for improvement in order that a third party uses driving diagnostic information.

An object of the present disclosure is to provide a driving diagnostic information management apparatus and a driving diagnostic information management method each of which allows a third party to use driving diagnostic information.

A driving diagnostic information management apparatus according to a first aspect of this disclosure includes a diagnostic information acquisition portion, a storage processing portion, a reception portion, and a providing portion. The diagnostic information acquisition portion is configured to acquire driving diagnostic information on a driver. The storage processing portion is configured to store the driving diagnostic information per driver in a storage portion. The reception portion is configured to receive a provision request on the driving diagnostic information. The providing portion is configured to, upon receipt of the provision request on the driving diagnostic information, provide the driving diagnostic information on a driver corresponding to the provision request.

In the driving diagnostic information management apparatus according to the first aspect, the diagnostic information acquisition portion acquires driving diagnostic information on a driver. Further, the storage processing portion stores the driving diagnostic information per driver in the storage portion. Here, in a case where a provision request on driving diagnostic information is received by the reception portion, the driving diagnostic information on a driver corresponding to the provision request is provided by the providing portion. Hereby, when a third party performs a provision request on driving diagnostic information, the third party can acquire the driving diagnostic information.

In the first aspect, the driving diagnostic information may include at least a driving level.

In the driving diagnostic information management apparatus configured as such, when the third party refers to the driving diagnostic information, the third party can easily grasp the driving level of the driver. Note that the “driving level” as used herein represents the driving skill of a driver quantitatively. The driving level is not limited to levels expressed as values and is a concept widely including contents classified by marks or the like.

In the above aspect, the driving diagnostic information may include at least vehicle information on a vehicle used at the time of driving diagnosis.

In the driving diagnostic information management apparatus configured as such, by referring to vehicle information on the vehicle used by the driver, the third party can grasp a vehicle type of a vehicle that the driver can drive.

In the above aspect, the driving diagnostic information may include at least information on a driving evaluation item.

In the driving diagnostic information management apparatus configured as such, by referring to the driving evaluation item at the time of diagnosis, the third party can grasp the driving skill more specifically.

A driving diagnostic information management method according to a second aspect of this disclosure includes: acquiring driving diagnostic information on a driver; storing the driving diagnostic information per driver; receiving a provision request on the driving diagnostic information; and providing, upon receipt of the provision request on the driving diagnostic information, the driving diagnostic information on a driver corresponding to the provision request.

As described above, with the driving diagnostic information management apparatus and the driving diagnostic information management method according to the present disclosure, a third party can use driving diagnostic information.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an overall configuration diagram of a driving diagnostic information management system according to an embodiment;

FIG. 2 is a block diagram illustrating a hardware configuration of a driving diagnostic information management apparatus according to the embodiment;

FIG. 3 is a block diagram illustrating a functional configuration of the driving diagnostic information management apparatus according to the embodiment;

FIG. 4 is a table illustrating an example of driving diagnostic information according to the embodiment; and

FIG. 5 is a sequence diagram illustrating an example of the procedure of a provision process according to the embodiment.

### DETAILED DESCRIPTION OF EMBODIMENTS

A driving diagnostic information management apparatus 10 according to an embodiment will be described with reference to the drawings.

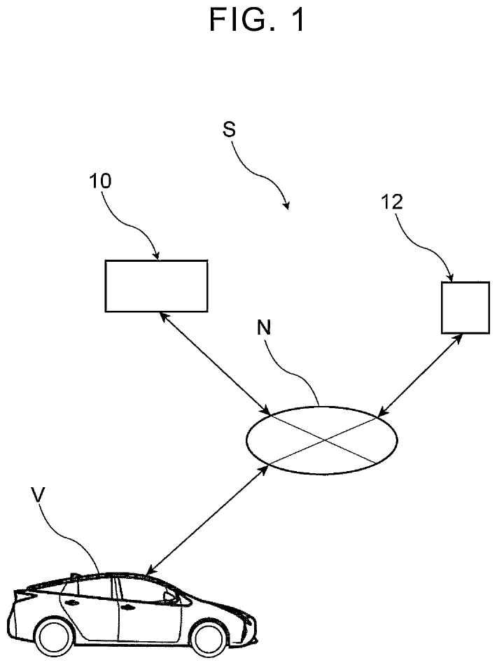

As illustrated in FIG. 1, a driving diagnostic information management system S of the present embodiment includes a driving diagnostic information management apparatus 10, a server 12 as a storage portion, and a vehicle V. The driving diagnostic information management apparatus 10, the server 12, and the vehicle V are connected to each other via a network N. Note that a plurality of vehicles V is connected to the network N. However, for purpose of this description, only one vehicle V is illustrated in FIG. 1.

The server 12 is a non-transitory recording medium in which information including driving diagnostic information is stored. More specifically, driving diagnostic information obtained by diagnosis based on detection results from various sensors provided in the vehicle V is sent to the server 12 and stored in the server 12.

Here, the driving diagnostic information management apparatus 10 of the present embodiment is configured to provide, upon receipt of a provision request on driving diagnostic information from outside, driving diagnostic information on a driver corresponding to the provision request.

Hardware Configuration of Driving Diagnostic Information Management Apparatus 10

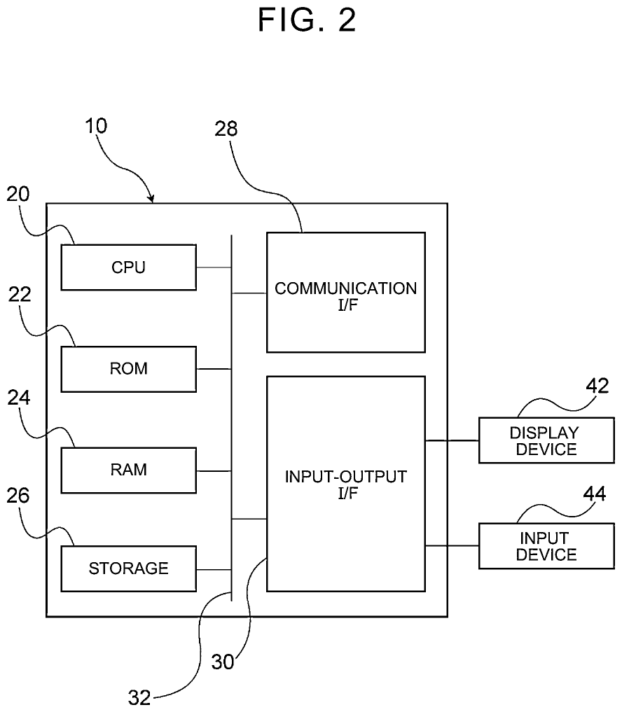

FIG. 2 is a block diagram illustrating a hardware configuration of the driving diagnostic information management apparatus 10. As illustrated in FIG. 2, the driving diagnostic information management apparatus 10 includes a central processing unit (CPU: a processor) 20, an read only memory (ROM) 22, a random access memory (RAM) 24, a storage 26, a communication interface (communication I/F) 28, and an input-output interface (input-output I/F) 30. Those constituents are connected to each other via a bus 32 in a mutually communicable manner.

The CPU 20 is a central processing unit and is configured to execute various programs and control each portion. That is, the CPU 20 reads a program from the ROM 22 or the storage 26 and executes the program in the RAM 24 as a working area. The CPU 20 is configured to perform respective controls on the constituents and various computing processes in accordance with programs stored in the ROM 22 or the storage 26.

In the ROM 22, various programs and various pieces of data are stored. A program or data is temporarily stored in the RAM 24 as a working area. The storage 26 is constituted by a hard disk drive (HDD) or a solid state drive (SSD) such that various programs including an operating system and various pieces of data are stored in the storage 26. In the present embodiment, programs and various pieces of data to perform processes are stored in the ROM 22 or the storage 26.

The communication I/F 28 is an interface for the driving diagnostic information management apparatus 10 to communicate with the server 12 and other devices, and standards such as Controller Area Network (CAN), Ethernet (registered trademark), Long Term Evolution (LTE), Fiber Distributed Data Interface (FDDI), and Wi-Fi (registered trademark) are used.

The input-output I/F 30 is electrically connected to a display device 42 and an input device 44. The display device 42 is configured to display various pieces of information including driving diagnostic information to a user. The input device 44 is a device via which the user inputs an instruction to acquire necessary information, and is, for example, a keyboard, a mouse, or the like.

Functional Configuration of Driving Diagnostic Information Management Apparatus 10

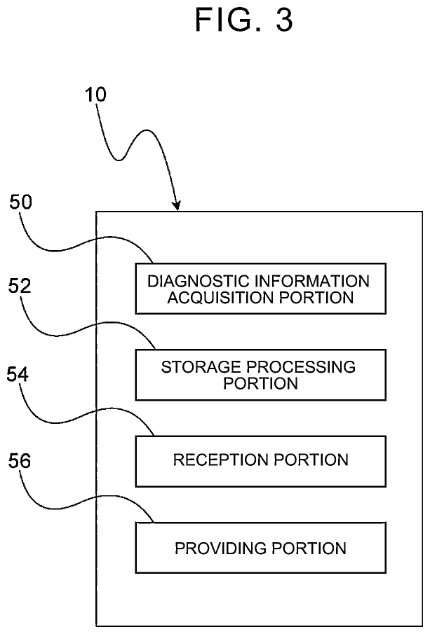

The driving diagnostic information management apparatus 10 implements various functions by use of the above hardware resources. Functional constituents implemented by the driving diagnostic information management apparatus 10 will be described with reference to FIG. 3.

As illustrated in FIG. 3 the driving diagnostic information management apparatus 10 includes, as functional constituents, a diagnostic information acquisition portion 50, a storage processing portion 52, a reception portion 54, and a providing portion 56. Note that the functional constituents are implemented such that the CPU 20 reads and executes programs stored in the ROM 22 or the storage 26.

The diagnostic information acquisition portion 50 acquires driving diagnostic information on a driver. More specifically, the diagnostic information acquisition portion 50 acquires driving diagnostic information on a driving skill of the vehicle V diagnosed by a driving diagnostic device (not illustrated).

In the present embodiment, the driving diagnostic device is provided in the vehicle V as an example, and the driving diagnostic device collects driving diagnostic information on a driver who drives the vehicle V. The driving diagnostic information is information including, for example, the number of times of sudden acceleration, the number of times of heavy braking, the number of times of sudden steering, the number of times of reverse, and so on. The sudden acceleration, the heavy braking, and the sudden steering may be detected by an acceleration sensor (not illustrated) and a steering angle sensor (not illustrated) provided in the vehicle V. Further, the number of times of reverse may be counted based on information on a shift range.

As other pieces of driving diagnostic information, a vehicle-to-vehicle distance, an excessive speed, and so on may be included. The vehicle-to-vehicle distance is calculated based on a video image captured by a front camera (not illustrated) provided in the vehicle V, for example. The number of times that the vehicle-to-vehicle distance is equal to or lower than a predetermined vehicle-to-vehicle distance may be counted as the driving diagnostic information.

Further, in the present embodiment, a driving level is included in the driving diagnostic information as an example. The driving level is a value calculated by a predetermined method based on driving evaluation items. In the present embodiment, the driving level is expressed by a value from 0 to 100. Further, the driving level is set such that the driving skill is higher as the driving level is closer to 100.

Note that the driving diagnostic device may be provided outside the vehicle V. In this case, the diagnostic information acquisition portion 50 acquires driving diagnostic information from a storage area where pieces of driving diagnostic information collected by the driving diagnostic device are stored.

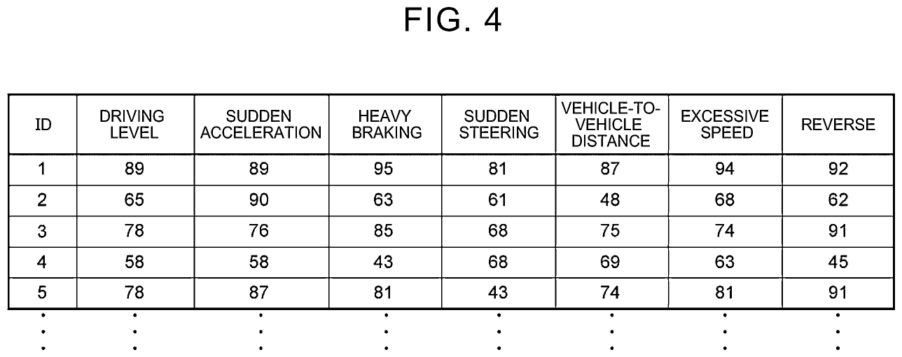

The storage processing portion 52 stores driving diagnostic information per driver in the server 12 as a storage portion. Examples of the driving diagnostic information stored in the server 12 are illustrated in FIG. 4.

As illustrated in FIG. 4, the driving diagnostic information includes an ID of a driver, a driving level, and scores of the driving evaluation items. Further, as examples of the driving evaluation items, sudden acceleration, heavy braking, sudden steering, vehicle-to-vehicle distance, excessive speed, and reverse are included.

As the number of times that a driving evaluation item applies to a driver, a lower score is calculated for the driving evaluation item. Further, the score is calculated as a value from 0 to 100. For example, in a case where sudden acceleration is never detected within a predetermined period of time, the score of the sudden acceleration is 100. The following describes outlines of the driving evaluation items.

The sudden acceleration and the heavy braking are counted based on signals from the acceleration sensor provided in the vehicle V. For example, a case where an acceleration of a predetermined value or more is detected by the acceleration sensor is counted as the sudden acceleration. Further, a case where the change amount of a speed per unit time is equal to or higher than a predetermined value based on a velocity sensor may be counted as the sudden acceleration. The sudden steering is counted based on a signal from the steering angle sensor. For example, a case where the change amount of a steering angle per unit time is equal to or higher than a predetermined value is counted as the sudden steering.

The vehicle-to-vehicle distance is counted in a case where the vehicle-to-vehicle distance from a leading vehicle is equal to or less than a predetermined distance based on a signal from the front camera or a sensor (not illustrated). For example, a case where the vehicle-to-vehicle distance from the leading vehicle is kept narrow for a predetermined period of time or more is counted as a vehicle-to-vehicle distance violation.

A case where the vehicle speed exceeds a speed limit is counted as the excessive speed. A case where the shift range is shifted to a reverse range is counted as the reverse. For example, a case where the vehicle reverses by a predetermined distance or more in a state where the shift range is at the reverse range is counted as the reverse. By setting the predetermined distance to be equal to or more than a distance required at the time of parking, the number of times that the vehicle reverses in states other than parking may be counted.

Note that, as other driving evaluation items, scores may be calculated for evaluation items on lane deviation, stop-sign violation, inattentive driving, and the like.

Further, the driving diagnostic information includes vehicle information on a vehicle used at the time of driving diagnosis. In a case where driving is diagnosed by use of predetermined types of vehicles, information such as a mark or the like corresponding to each vehicle is input as the vehicle information. Further, in a case where a driver can freely determine a vehicle to be used for driving diagnosis, information on a vehicle model or the like is input as the vehicle information.

The reception portion 54 receives a provision request on driving diagnostic information. For example, in a case where an instruction on provision of driving diagnostic information is input via the input device 44, the reception portion 54 receives a provision request on driving diagnostic information. Further, the reception portion 54 may receive an instruction on a provision request on driving diagnostic information from outside via a network such as the Internet.

When the reception portion 54 receives the provision request on driving diagnostic information, the providing portion 56 provides driving diagnostic information on a driver corresponding to the provision request. That is, the providing portion 56 accesses the server 12 via the network N and acquires driving diagnostic information corresponding to a condition received by the reception portion 54. Further, the providing portion 56 transmits the driving diagnostic information thus acquired to a request source. For example, in a case where the reception portion 54 receives a provision request on driving diagnostic information with a driving level of 80 or more, the providing portion 56 acquires only data with a driving level of 80 or more from data on pieces of driving diagnostic information stored in the server 12 and transmits the data thus acquired to a request source.

Operation

Next will be described the operation of the present embodiment.

Example of Provision Process

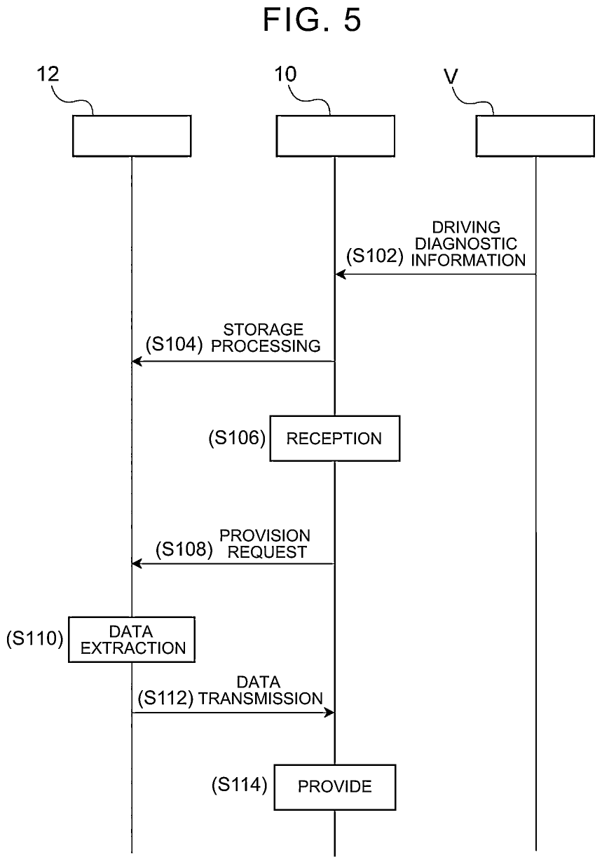

FIG. 5 is a sequence diagram illustrating an example of the procedure of a provision process according to the present embodiment. Herein, processes of the driving diagnostic information management apparatus 10, the server 12, and the vehicle V are described. Note that the provision process is executed such that the CPU 20 reads a program from the ROM 22 or the storage 26 and executes the program by developing the program in the RAM 24.

In step S102, the CPU 20 acquires driving diagnostic information. More specifically, the CPU 20 sends a signal to the driving diagnostic device provided in the vehicle V by a function of the diagnostic information acquisition portion 50. The driving diagnostic information is transmitted from the vehicle V to the driving diagnostic information management apparatus 10.

In step S104, the CPU 20 stores the acquired driving diagnostic information in the server 12. More specifically, the CPU 20 transmits data on the driving diagnostic information to a predetermined storage area of the server 12 by a function of the storage processing portion 52. At this time, the storage processing portion 52 may update part of data in a database and may add data on new driving diagnostic information to the database.

In step S106, the CPU 20 receives a provision request on driving diagnostic information from outside. More specifically, the CPU 20 receives a provision request by a function of the reception portion 54 when a requester inputs the provision request via the input device 44. Further, the reception portion 54 may receive a provision request on driving diagnostic information from an external terminal via the Internet.

In step S108, a provision request from the driving diagnostic information management apparatus 10 to the server 12 is performed. More specifically, the CPU 20 instructs the server 12 to provide data on driving diagnostic information based on a content received by the reception portion 54, by a function of the providing portion 56.

In step S110, data that satisfies a condition instructed by the providing portion 56 is extracted from the server 12. For example, in a case where the driving level is specified to 80 or more, only driving diagnostic information with a driving level of 80 or more is extracted from among pieces of data accumulated in the database. In addition, the provision request on driving diagnostic information can be performed under various conditions. For example, only driving diagnostic information on a specific vehicle may be extracted. Further, only driving diagnostic information with a high score of a specific driving evaluation item may be extracted.

In step S112, the CPU 20 receives driving diagnostic information transmitted from the server 12. In step S114, the CPU 20 provides the driving diagnostic information to a request source by a function of the providing portion 56. More specifically, in a case where the provision request on driving diagnostic information is received via the input device 44, the CPU 20 provides the driving diagnostic information to the request source by displaying the driving diagnostic information on the display device 42. Further, in a case where the instruction on the provision request on driving diagnostic information is received from outside via the Internet, the CPU 20 transmits the driving diagnostic information to a terminal of the request source via the Internet.

As described above, in the driving diagnostic information management apparatus 10 according to the present embodiment, the diagnostic information acquisition portion 50 acquires driving diagnostic information on a driver. Further, the storage processing portion 52 stores driving diagnostic information per driver in the server 12. Here, in a case where a provision request on driving diagnostic information is received by the reception portion 54, driving diagnostic information on a driver corresponding to the provision request is provided by the providing portion 56. Hereby, by performing a provision request on driving diagnostic information, a third party can acquire the driving diagnostic information.

Further, in the present embodiment, the driving diagnostic information includes the driving level. Accordingly, by referring to the driving diagnostic information, the third party can easily grasp the driving level of a driver.

Further, in the present embodiment, since the driving diagnostic information includes the vehicle information, the third party can grasp a vehicle type that the driver can drive.

Furthermore, in the present embodiment, the driving diagnostic information includes the driving evaluation items. Accordingly, by referring to the driving evaluation items at the time of diagnosis, the third party can grasp the driving skill more specifically. For example, in a case where a person in charge of recruitment of taxi driver considers recruiting a driver who drives a vehicle at the regulation speed, the person can easily find a desired driver by acquiring driving diagnostic information with a high score in excessive speed.

The driving diagnostic information management apparatus 10 according to the embodiment and modifications has been described above, but it is needless to say that the present disclosure can be carried out in various forms within a range that does not deviate from the gist of the present disclosure. For example, in the above embodiment, driving diagnostic information on a driver is collected by the driving diagnostic device provided in the vehicle V. However, the present disclosure is not limited to this, and the driving diagnostic device may be provided outside the vehicle V. Further, a person may perform driving diagnosis without using the sensors provided in the vehicle V. In this case, the person who performs the driving diagnosis may input a driving diagnosis result into a terminal to register driving diagnostic information.

Further, in the above embodiment, the driving level is calculated as a value from 0 to 100. However, the present disclosure is not limited to this. For example, the driving level may be evaluated based on five levels from 1 to 5. Further, the evaluation may be expressed as “Excellent,” “Good,” “Fair,” “Poor,” and the like.

Further, a process executed by the CPU 20 by reading a program in the above embodiment may be executed by various processors other than the CPU 20. Examples of the processors in this case include a programmable logic device (PLD) such as a field-programmable gate array (FPGA) the circuit configuration of which is changeable after manufacture, an exclusive electric circuit such as an application specific integrated circuit (ASIC) as a processor having a circuit configuration designed for exclusive use of executing a specific process, and so on. Further, each process may be executed by one of these various processors or may be executed by a combination of two or more processors of the same type or different types. For example, each process may be executed by a plurality of FPGAs, a combination of a CPU and an FPGA, or the like. Further, hardware structures of these various processors are electric circuits obtained by combining circuit elements such as semiconductor elements, more specifically.

What is claimed is:

1. A driving diagnostic information management apparatus comprising:
a diagnostic information acquisition portion configured to acquire driving diagnostic information on a driver;
a storage processing portion configured to store the driving diagnostic information per driver in a storage portion;
a reception portion configured to receive a provision request on the driving diagnostic information; and
a providing portion configured to, upon receipt of the provision request on the driving diagnostic information, provide the driving diagnostic information on a driver corresponding to the provision request.

2. The driving diagnostic information management apparatus according to claim 1, wherein the driving diagnostic information includes at least a driving level.

3. The driving diagnostic information management apparatus according to claim 1, wherein the driving diagnostic information includes at least vehicle information on a vehicle used at the time of driving diagnosis.

4. The driving diagnostic information management apparatus according to claim 1, wherein the driving diagnostic information includes at least information on a driving evaluation item.

5. A driving diagnostic information management method comprising:
acquiring driving diagnostic information on a driver;
storing the driving diagnostic information per driver;
receiving a provision request on the driving diagnostic information; and
providing, upon receipt of the provision request on the driving diagnostic information, the driving diagnostic information on a driver corresponding to the provision request.
